(19) United States
(12) Patent Application Publication
(10) Pub. No.: US 2019/0325593 A1
(43) Pub. Date: Oct. 24, 2019

(54) IMAGE PROCESSING APPARATUS, SYSTEM, METHOD OF MANUFACTURING ARTICLE, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Takumi Tokimitsu, Utsunomiya-shi (JP)

(21) Appl. No.: 16/383,960

(22) Filed: Apr. 15, 2019

(30) Foreign Application Priority Data
Apr. 24, 2018 (JP) 2018-083368

(51) Int. Cl. G06T 7/521; G06T 7/73; G06T 3/60; G06T 7/00; B25J 9/16

(52) U.S. Cl. CPC G06T 7/521; G06T 7/73; G06T 2207/20212; G06T 7/0012; B25J 9/1664; G06T 3/60

(57) ABSTRACT

For each pixel corresponding to a line detected from an image of an object that has been obtained by an image obtainment unit configured to obtain the image of the object on which a pattern including the line has been projected, a tilt of the line corresponding to the pixel is obtained. The line in the image is detected based on the tilt obtained for each pixel.

### BACKGROUND OF THE INVENTION

### Field of the Invention

The present invention relates to a technique for detecting a line from an image.

### Description of the Related Art

As a technique for measuring the surface shape of an object, there is a method called an optical active stereo method. In this method, three-dimensional information of an object to be inspected is measured by causing a projector to project a predetermined projection pattern onto the object, performing image capturing from a direction different from the projection direction, and calculating the distance information of each pixel position based on the principle of triangulation.

There are various kinds of methods related to the pattern used in the active stereo method. As one of such methods, there is known a method of projecting a pattern in which disconnected points (dots) are arranged in a line pattern (to be referred to as a dot line pattern method hereinafter) as disclosed in Japanese Patent No. 2517062. In this method, since an index indicating which of the detected lines corresponds to which line on the projection pattern is provided based on the coordinate information of each dot detected on the line, the three-dimensional distance information of the overall object can be obtained by performing an image capturing operation once.

In addition, Japanese Patent Laid-Open No. 2016-200503 discloses a technique to improve the density of distance points to be measured by detecting the line peaks and the line edges when executing line detection by the dot line pattern method. Japanese Patent Laid-Open No. 2016-200503 also discloses a technique to remove the negative peak of a line and a line edge position near a dot from a measurement point since their presence can degrade the detection accuracy.

In the measurement by the dot line pattern method, a sufficient number of dots need to be detected for dot coordinate information association between the detected dots and the respective pieces of coordinate information of the dots in the pattern information. Hence, it is preferable to set a high density of dots in the pattern so that a sufficient number of dots will be projected onto the object even when the size of the object is small.

In this case, if the measurement points near a dot are removed in the manner of the technique disclosed in Japanese Patent Laid-Open No. 2016-200503, it will decrease the distance measurement point density. In addition, since not only the negative peak of a line and the line edge, but also the peak detection accuracy will greatly degrade when the measurement line tilts from a pixel array (as will be described later), the improvement of the detection accuracy is desired more than the removal of measurement points.

### SUMMARY OF THE INVENTION

The present invention provides a technique to detect, with high accuracy, a line from an image of an object to be inspected onto which a pattern including the line has been projected.

According to the first aspect of the present invention, there is provided an image processing apparatus comprising: an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel; and a detection unit configured to detect the line in the image based on the tilt obtained by the obtainment unit for each pixel.

According to the second aspect of the present invention, there is provided a system comprising: an image processing apparatus that includes an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel, and a detection unit configured to detect the line in the image based on the tilt obtained by the obtainment unit for each pixel; and a robot configured to hold and move the object based on a measurement result obtained by the image processing apparatus.

According to the third aspect of the present invention, there is provided a method of manufacturing an article, the method comprising: measuring an object by using an image processing apparatus that includes an obtainment unit configured to obtain, for each pixel corresponding to a line detected from an image of the object that has been obtained by an image obtainment unit configured to obtain the image of the object on which a pattern including the line has been projected, a tilt of the line corresponding to the pixel, and a detection unit configured to detect the line in the image based on the tilt obtained by the obtainment unit for each pixel; and manufacturing the article by processing the object based on the measurement result.

According to the fourth aspect of the present invention, there is provided an image processing method performed by an image processing apparatus, the method comprising: obtaining, for each pixel corresponding to a line detected from an image of an object that has been obtained by an image obtainment unit configured to obtain the image of the object on which a pattern including the line has been projected, a tilt of the line corresponding to the pixel; and detecting the line in the image based on the tilt obtained for each pixel.

According to the fifth aspect of the present invention, there is provided a non-transitory computer-readable storage medium storing a computer program for causing a computer to function as: an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel; and a detection unit configured to detect the line in the image based on the tilt obtained by the obtainment unit for each pixel.

Further features of the present invention will become apparent from the following description of exemplary embodiments (with reference to the attached drawings).

### BRIEF DESCRIPTION OF THE DRAWINGS

FIG. 1A is a view showing an example of the arrangement of a three-dimensional coordinate measurement apparatus 100 and FIGS. 1B and IC are views each showing an example of an object 5 to be inspected;

FIGS. 2A to 2C are views showing examples of a dot line pattern and a captured image;

FIG. 3 is a flowchart of processing performed by an arithmetic processing unit 4;

FIGS. 4A and 4B are views showing examples of Sobel filters and FIG. 4C is a view showing an example of a rotation differential filter;

FIGS. 5A to 5C are views showing examples of line coordinate points;

FIGS. 6A to 6D are views for explaining how line coordinate detection error is caused by dot portions;

FIGS. 7A and 7B are views showing examples of the arrangement of a map;

FIG. 8 is a flowchart of processing performed by an arithmetic processing unit 4; and

FIG. 9 is a view showing an example of the arrangement of a control system.

### DESCRIPTION OF THE EMBODIMENTS

The embodiments of the present invention will now be described with reference to the accompanying drawings. Note that the embodiments to be described below are examples of detailed implementation of the present invention or detailed examples of the arrangement described in the appended claims.

### First Embodiment

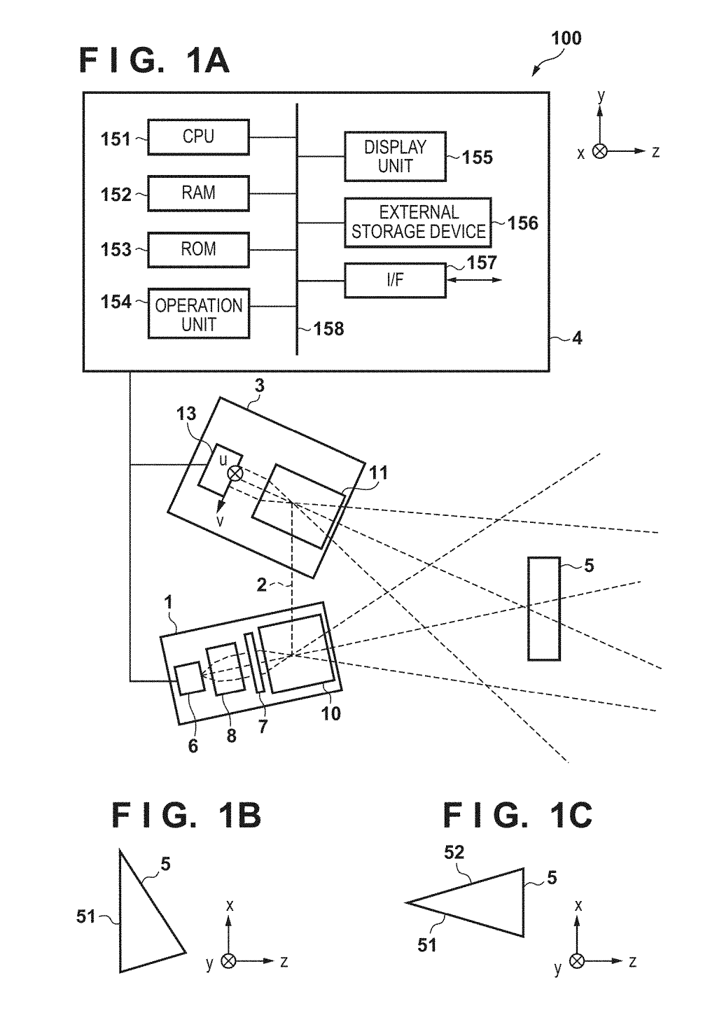

This embodiment will describe a measurement system that projects a pattern (line pattern) including lines (measurement lines) onto an object (object to be inspected), performs image capturing of the object onto which the line pattern has been projected, and measures the three-dimensional shape of the object based on the image obtained by the image capturing. FIG. 1A shows an example of an arrangement of a three-dimensional coordinate measurement apparatus 100 according to this embodiment to which this kind of measurement system has been applied.

As shown in FIG. 1A, the three-dimensional coordinate measurement apparatus 100 includes a projector 1 serving as an example of a projection device, an image capturing unit 3 serving as an example of an image capturing device, and an arithmetic processing unit 4 serving as an example of a computer device. The projector 1 and the image capturing unit 3 are connected to the arithmetic processing unit 4.

The projector 1 will be described first. A light beam emitted from an LED 6 is condensed by an illumination optical system 8 and illuminates a spatial modulation element 7. The spatial modulation element 7 modulates the incident light beam from the illumination optical system 8 and emits “a pattern which includes a plurality of lines (a line pattern)” (adds a line pattern to the light beam from the LED 6). The line pattern emitted from the spatial modulation element 7 is projected onto an object 5 to be inspected via a projection optical system 10. Note that the projection device is not limited to the projector 1 shown in FIG. 1A if it is a device capable of projecting the line pattern described above to the object 5.

The image capturing unit 3 will be described next. Light from the outside enters an image sensor 13 via an image capturing optical system 11. Pixels are two-dimensionally arrayed on the image sensor 13 (pixels are arrayed in a u-axis direction and a v-axis direction as shown in FIG. 1A), a captured image is generated based on the received light amount of each pixel, and the captured image is output to the arithmetic processing unit 4. Note that the u-axis and the v-axis are perpendicular to each other. Thus, in the case of FIG. 1A, the image capturing unit 3 outputs a captured image (line pattern image) to the arithmetic processing unit 4 by generating the captured image of the object 5 onto which a line pattern has been projected by the projector 1. Note that as long as it is a device capable of generating a captured image of the object 5 onto which the line pattern has been projected and outputting the generated captured image to the arithmetic processing unit 4, the image capturing device is not limited to the image capturing unit 3 of FIG. 1A.

The projector 1 and the image capturing unit 3 are arranged here at a distance apart from each other by a baseline 2 which is a line between the main points of the two units. Assume that the longitudinal direction of the plurality of lines included in the line pattern is the X-axis direction perpendicular to the baseline 2, and the u-axis direction of the image sensor 13 is arranged almost equal to the X-axis direction and is almost perpendicular to the epipolar

The arithmetic processing unit 4 will be described next. The arithmetic processing unit 4 is a computer device that can execute processing operations to be described later as processing operations to be performed by the arithmetic processing unit 4, and includes the following hardware arrangement, for example

A CPU 151 executes various kinds of processing by using computer programs and data stored in a RAM 152 and a ROM 153. This allows the CPU 151 to control the overall operation of the arithmetic processing unit 4 as well as to execute or control each processing operation to be described later as that to be performed by the arithmetic processing unit 4.

The RAM 152 includes an area for storing the computer programs and data loaded from the ROM 153 and an external storage device 156, data (for example, a captured image received from the image capturing unit 3) received from the outside via an I/F (interface) 157, and the like. Furthermore, the RAM 152 includes a work area used by the CPU 151 to execute the various kinds of processing. In this manner, the RAM 152 can appropriately provide various kinds of areas. The ROM 153 stores information that need not be rewritten such as the setting data of the arithmetic processing unit 4, the activation program, and the like.

An operation unit 154 is a user interface such as keyboard and a mouse, and a user can operate the operation unit to input various kinds of instructions to the CPU 151. A display unit 155 is formed by a liquid crystal screen, a touch panel, or the like, and can display a processing result obtained by the CPU 151 by using an image, characters, and the like. In addition, if the display unit 155 is a touch panel, the CPU 151 will be notified of an operation input to the touch panel by the user.

The external storage device 156 is a large-capacity information storage device represented by a hard disk drive device. The external storage device 156 stores an OS (operating system) and computer programs and data for the CPU 151 to execute or control the processing operations (to be described later) to be executed by the arithmetic processing unit 4. The data stored in the external storage device 156 includes data to be handled as known information in the following description, data of the line pattern to be projected by the projector 1, and the like. The computer programs and data stored in the external storage device 156 are loaded into the RAM 152 under the control of the CPU 151 and become a processing target of the CPU 151.

The I/F 157 functions as an interface to perform data communication with an external apparatus, and the projector 1 and the image capturing unit 3 are connected to the I/F 157 in the arrangement shown in FIG. 1A. The CPU 151, the RAM 152, the ROM 153, the operation unit 154, the display unit 155, the external storage device 156, and the I/F 157 are connected to a bus 158.

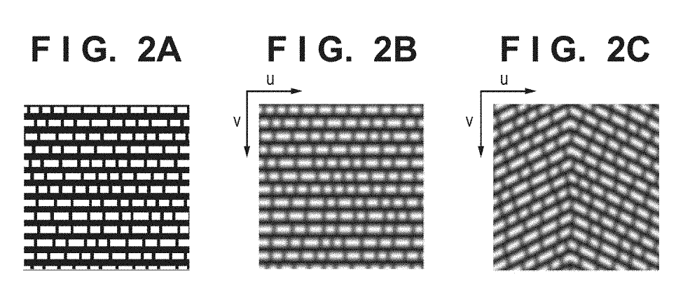

The arithmetic processing unit 4 which has the arrangement as described above detects the coordinate points (line coordinates) of each line included in the captured image obtained from the image capturing unit 3. Line coordinate detection is performed by detecting each coordinate point on the captured image from the peak of the received light amount obtained from the captured image. In a pattern projection method which uses a plurality of line patterns, the association of captured line pattern needs to be performed. Line pattern association is a processing procedure performed to associate each line detected from an image with information indicating which line it is out of the lines included in the line pattern added by the spatial modulation element 7. Although a plurality of methods are known for performing the above-described association from a plurality of line pattern images, this embodiment will use, as the line pattern to be projected by the projector 1, “a dot line pattern indicating a part of a pattern shown FIG. 2A that has been encoded by randomly arranged dots (disconnected points)” which allows association to be performed from a single line pattern image as disclosed in Japanese Patent No. 2517062 and Japanese Patent Laid-Open No. 2016-200503.

As a result of performing the above-described association on the line coordinate points detected from the captured image, the arithmetic processing unit 4 obtains the three-dimensional shape (the three-dimensional coordinate points of the positions on the surface of the object 5) of the object 5 based on the optical characteristics of the projector 1 and the image capturing unit 3 that have been calibrated in advance and the relative positional relationships.

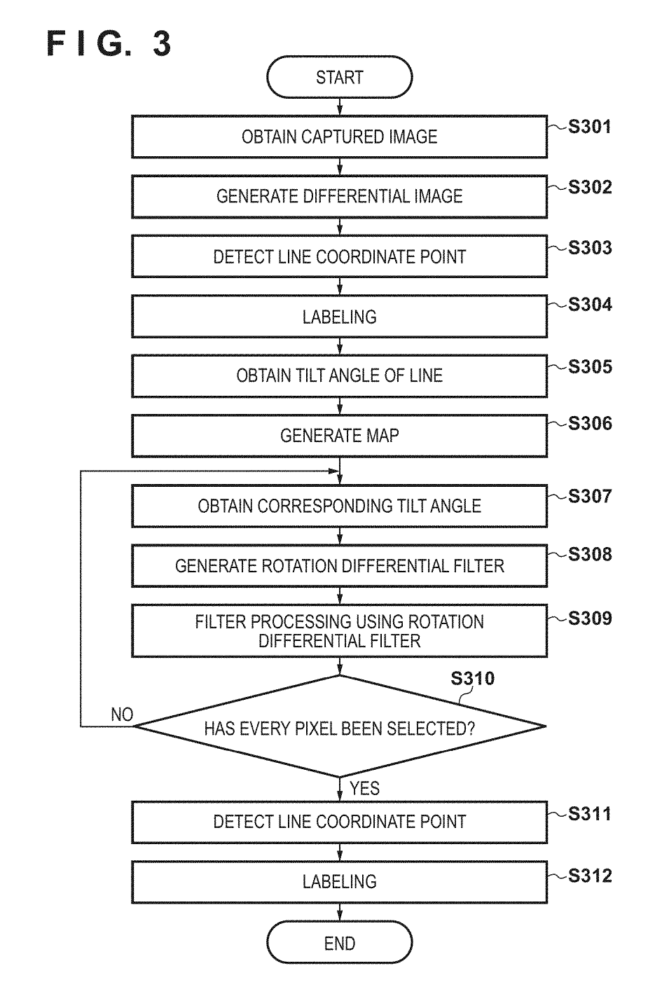

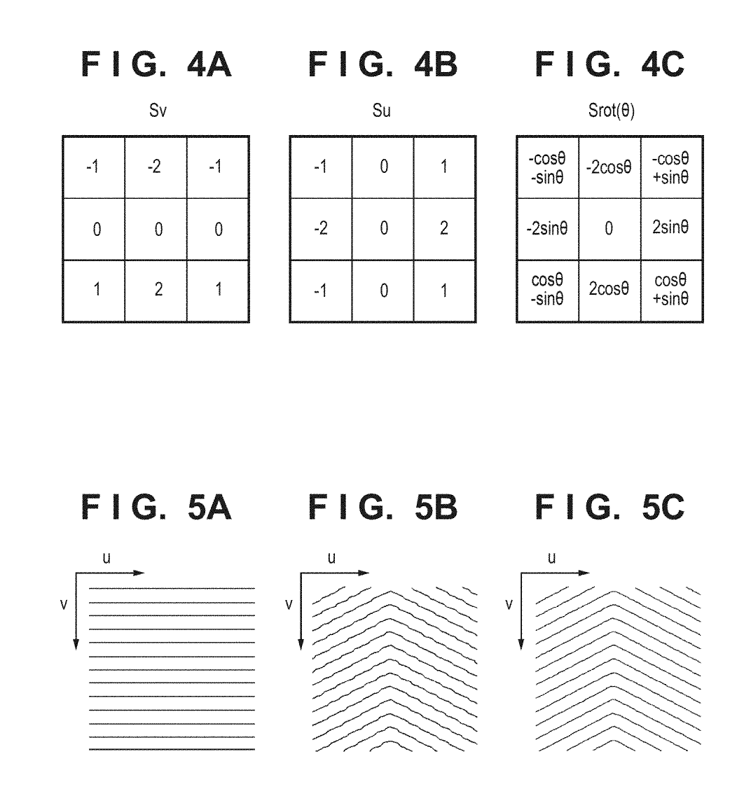

The processing performed by the arithmetic processing unit 4 to detect each line from a captured image by the image capturing unit 3 will be described with reference to FIG. 3 showing the flowchart of the processing. In step S301, the CPU 151 loads a captured image transmitted from the image capturing unit 3 into the RAM 152 via the I/F 157. In step S302, the CPU 151 generates a differential image gv by applying a Sobel filter Sv having the differential direction in the v-axis direction to each pixel of a captured image f which was loaded into the RAM 152 in step S301. An example of the arrangement of the Sobel filter Sv is shown in FIG. 4A. The application of the Sobel filter Sv to each pixel of the captured image f is performed by, for example, a convolution operation of the captured image f and the Sobel filter Sv by

gv(u,v)=Σₙ₌₋₁¹Σₘ₌₋₁¹f(u+m,v+n)Sv(m,n) (1)

where f(u, v) represents a pixel value of a pixel position (u, v) in the captured image f, and Sv(m, n) represents an element value at a relative position (m, n) with respect to the center position of the Sobel filter Sv when the center position is set to (0, 0). In addition, gv (u, v) represents a pixel value (luminance value) at the pixel position (u, v) in the differential image gv. Assume that the u-axis direction and the v-axis direction are the horizontal direction and the vertical direction, respectively, in each image (a captured image, a differential image, or the like) hereinafter.

In step S303, for each vertical line (a v-axis direction line for each u coordinate) of the differential image gv generated in in step S302, the CPU 151 detects, as a line coordinate point, a coordinate point (peak position) where a differential value changes from positive to negative in a luminance distribution of the vertical line. For example, in a case in which the line coordinate point is to be detected from a vertical line of interest, the CPU will detect, as the line coordinate point, a coordinate point (peak position) where the differential value has changed from positive to negative in the luminance distribution (each luminance value between pixels is obtained by interpolation or the like) formed from the luminance values of the respective pixels forming the vertical line of interest. In this case, since the luminance distribution is a continuous function in the vertical line direction, a u-coordinate value of a line coordinate point is an integer value (the u-coordinate value of the vertical line from which the line coordinate point was detected), and the v-coordinate value of a line coordinate point is a real number (peak position).

Also, since even a dot portion where the line is broken needs to be detected in a state where the line is continuous, a filter for smoothing the luminance values of the dots and the lines to be observed on the captured image can be applied to the captured image before the application of the Sobel filter. This smoothing processing need not be performed when there is enough blur (contrast degradation) caused by the optical system and the line can be detected in a continuous state even in in the dot portion.

Next, in step S304, the CPU 151 performs line labeling on the line coordinate point obtained in step S303. In line labeling, a line coordinate point which is adjacent (it may also be apart by a predetermined number of pixels) to the line coordinate point of interest in the u-axis direction is set as the coordinate point of a point on the same line as the line coordinate point of interest, and the same label as the line coordinate point of interest is assigned to the line coordinate point.

Subsequently, among the lines formed by line coordinate points with the same label assignment, the CPU 151 specifies a line whose length (for example, the number of pixels in the u-axis direction or the v-axis direction) is equal to or more than a predetermined value, and each line coordinate point forming the specified line is set as a first line coordinate point. Note that the CPU 151 will determine a line whose length is less than the predetermined value to be noise, and a line coordinate point forming this line will be set as a non-line coordinate point.

FIG. 2B shows an example of a captured image obtained by the image capturing unit 3 when a surface 51 of the object 5 faces the image capturing unit 3 (that is, the surface 51 is almost perpendicular to the image capturing unit 3) as shown in FIG. 1B. Since the captured image shown in FIG. 2B is obtained by capturing the line pattern projected onto the surface 51 which directly faces the image capturing unit 3, lines which are almost completely parallel to the u-axis are captured in the image. FIG. 5A shows the line coordinate points (the first line coordinate points) that can be obtained by performing the processes of steps S302 to S304 described above on the captured image when the captured image shown in FIG. 2B is obtained in step S301. Dots (black) have been written on the positions corresponding to the line coordinate points in FIG. 5A. Since lines which are almost parallel to the u-axis are captured in the captured image shown in FIG. 2B, the line coordinate points form lines almost parallel to the u-axis as shown in FIG. 5A.

FIG. 2C shows an example of a captured image obtained by the image capturing unit 3 when the surface 51 and a surface 52 (the two surfaces tilted about the Y-axis with respect to the image capturing unit 3) of the object 5 are included (the boundary portion of the surface 51 and the surface 52 is included) in the image capturing range of the image capturing unit 3 as shown in FIG. 1C. In the captured image shown in FIG. 2C, the line pattern projected onto each of the surfaces 51 and 52 is captured as a line pattern tilted with respect to the u-axis. FIG. 5B shows the line coordinate points (first line coordinate points) that can be obtained by performing the processes of steps S302 to S304 described above on the captured image when the captured image shown in FIG. 2C is obtained in step S301. Dots (black) have been written on the positions corresponding to the line coordinate points in FIG. 5B. Since a line pattern which is tilted with respect to the u-axis is captured in the captured image shown in FIG. 2C, the line coordinate points form lines tilted with respect to the u-axis as shown in FIG. 5B. Assume here that, as shown in FIG. 5B, a detection error has occurred in the line coordinate points due to the dot portion. That is, although straight lines are obtained in the detection result for each surface when the surface 51 and the surface 52 are flat surfaces, waves are generated in portions corresponding to the dot portions.

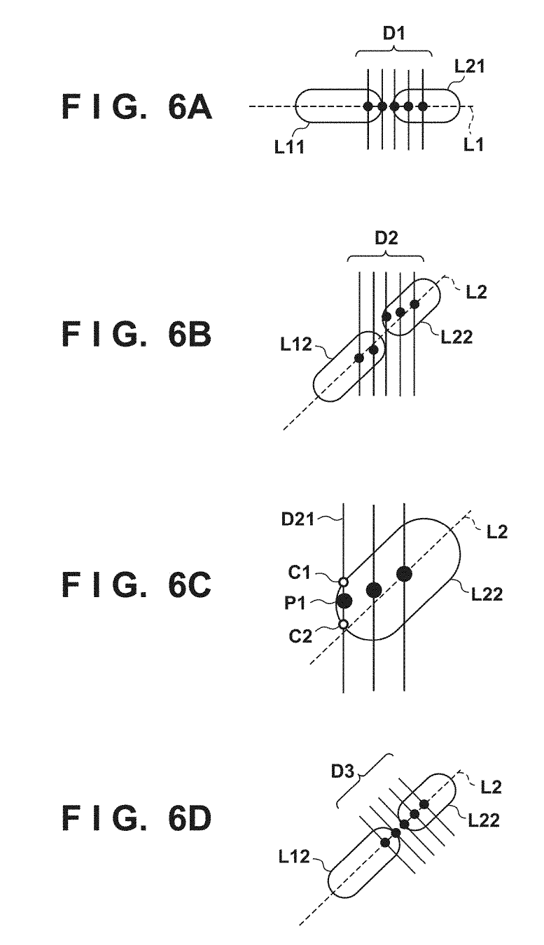

The reason why a line coordinate point detection error is caused by a dot portion when a tilted line pattern is captured in the captured image will be described with reference to FIGS. 6A to 6D. FIG. 6A is a view showing line coordinate points detected from a differential image obtained by performing differentiation in the v-axis direction on a captured image in which lines almost parallel to the u-axis have been captured. In FIG. 6A, a reference symbol L1 denotes a center line of a line, and reference symbols L11 and L21 denote the bright portions of the line that have been broken by dots. However, as described above, in the actual light amount distribution, the bright portions L1 and L21 have undergone smoothing to an extent which allows them to be detected as a same line in a continuous state, and the corner portions near the dots in the bright portions L11 and L21 are blurred in the light amount distribution. Reference symbol D1 denotes the differential direction (v-axis direction) with respect to the captured image for each vertical line, and is almost perpendicular to the line. A black circle is a line coordinate point detected for each vertical line. In a case in which the line is almost parallel to the u-axis as shown in FIG. 6A, the center line L1 of the line and the line coordinate points will almost match, and the line coordinate detection can be performed without an error.

FIG. 6B is a view showing line coordinate points detected from a differential image obtained by performing differentiation, in the v-axis direction, on a captured image in which a line tilted with respect to the u-axis have been captured. In FIG. 6B, a reference symbol L2 denotes a center line of the lines, and reference symbols L12 and L22 denote the bright portions of the lines that have been broken by dots in the same manner as in FIG. 6A. Similarly to the bright portions L11 and L21 described above, the light amount distribution is blurred in the corner portions near the dots in the bright portions L12 and L22. Reference symbol D2 denote the differential direction (v-axis direction) with respect to the captured image for each vertical line, and the lines are tilted with respect to the differential direction. A black circle is a line coordinate point detected for each vertical line. In a differential image obtained by performing differentiation in the v-axis direction on a captured image in which lines are tilted with respect to the u-axis as shown in FIG. 6B, a case in which a position shifted from the center line L2 of the line is detected as a line coordinate point will occur. The cause of this shift will be described with reference to FIG. 6C which shows an enlarged view of the periphery of the bright portion L22 shown in FIG. 6B.

When the contour line of the bright portion L22 shown in FIG. 6C is seen as the contour line of the light amount, a middle point (a position P1 shifted from the center line L2 of the line) between two intersection points C1 and C2 of (the contour line of) the bright portion L22 and a search line D21 for searching the peak positions in the luminance distribution will be detected as a line coordinate point. In this manner, when a peak position search is executed in the v-axis direction on the differential image obtained by performing differentiation in the v-axis direction on a captured image in which lines are tilted with respect to the u-axis, an error will occur in the line coordinate detection near the dot portion because the dot portion will act like noise to the line. Such an error can be effectively reduced by performing line coordinate detection from a differential image obtained by performing differentiation on the captured image in a differential direction D3 corresponding to the tilt of the line as shown in FIG. 6D. In the differential image obtained by performing differentiation on the captured image in a differential direction D3 corresponding to the tilt of the line, the peak positions (black circles) appear on the center line L2 of the line as shown in FIG. 6D. Thus, even when peak positions are searched for in the v-axis direction of such a differential image, it is possible to detect the line coordinate points on the center line L2 of the line, and line detection can be performed with good accuracy while reducing the influence of the dots.

In step S305 and its subsequent steps, the tilt of the line of the first line coordinate points obtained by the processes performed until step S304 is obtained, and line detection is performed from the differential image obtained by performing differentiation on the captured image in accordance with the tilt. In step S305, the CPU 151 obtains, for each set of first coordinate line points (that is, for each set of first lines forming the same line) with the same label assignment, a line tilt angle α of each first line coordinate point included in the set. For example, in each first line coordinate point included in a set of interest, assume that v(n) is the v-coordinate value of a first line coordinate point P(n) whose u-coordinate value is n (n is an integer). At this time, the line tilt angle α of P(n) can be obtained by calculating α=arctan((v(n−1)−v(n+1))/2). Note that in the set of interest, the line tilt angle a of a first line coordinate point (=umin) with the smallest u-coordinate value can employ the same angle as the line tilt angle α of a first line coordinate point P(umin+1). In addition, in the set of interest, the line tilt angle 60 of a first line coordinate point (umax) with the largest u-coordinate value can employ the same angle as the line tilt angle α of a first line coordinate point P(umax−1). In this manner, the line tilt angle a is obtained for every first line coordinate point in step S305.

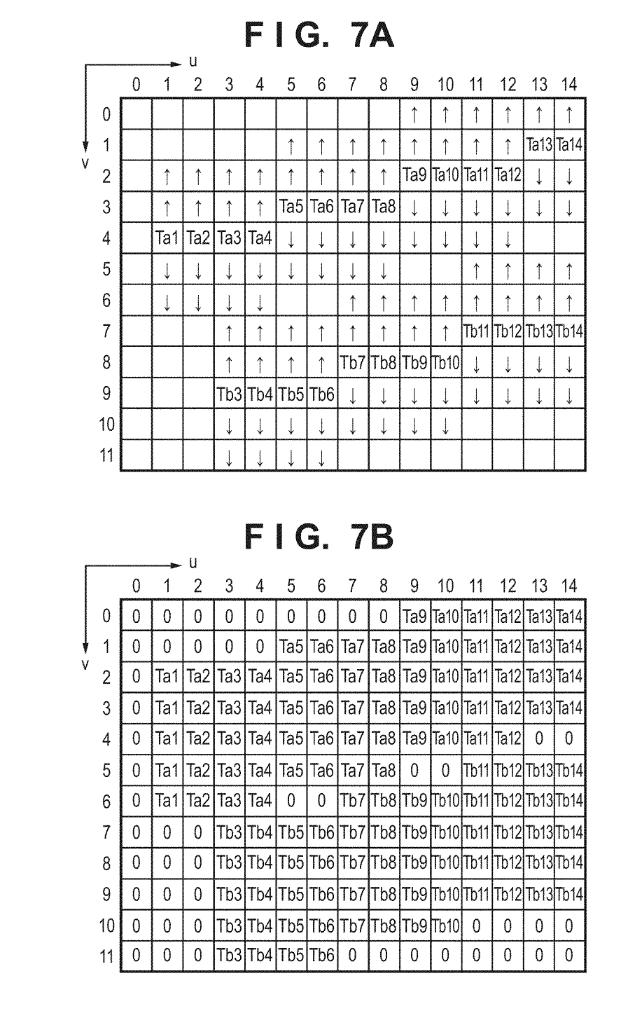

In step S306, the CPU 151 generates a map in which the tilt angle corresponding to each pixel of the captured image is registered. FIG. 7A shows an example of the arrangement of the map. Assume that the u-axis and the v-axis denote the horizontal direction and the vertical direction, respectively, of the map. A tilt angle corresponding to a pixel position (u, v) in the captured image will be registered in an element (cell) at a position (u, v) on the map. In this embodiment, in order to generate such a map, a tilt angle obtained for a first line coordinate point (u, y) will be registered at a position (u, Z(y)) on the map. Here, Z(y) is a function to return the integer part of y. Z(y) is function in which, for example, one is added to the integer part of y and the fractional part of y is rounded down if the fractional part of y is equal to or more than 0.5, and the fractional part of y is rounded down and the integer portion of y is not changed if the fractional part of y is less than 0.5.

In the example shown in FIG. 7A, in a map that is generated in this manner, a tilt angle Ta1 is registered in an element (cell) at, for example, a position (u, v)=(1, 4). Note that in FIG. 7A, the tilt angles corresponding to the respective first line coordinate points that have been assigned a label “a” are denoted as Ta1, Ta2, . . . , Ta14, and the tilt angles corresponding to the respective first line coordinate points that have been assigned a label “b” are denoted as Tb3, Tb4, . . . , Tb14. Txy represents a tilt angle of each first line coordinate point whose u-coordinate value is “2” among the first coordinate line points that have been assigned a label “x”.

Next, as shown in FIG. 7A, the CPU 151 will copy the tilt angle of an element with the registration of a tilt angle to two elements above and two elements below the element, and will register 0 in an element without the registration of a tilt angle. For example, as shown in FIGS. 7A and 7B, the tilt angle Ta1 is registered to the two elements above (elements at positions (1, 2) and (1, 3)) and two elements below (elements at positions (1, 5) and (1, 6)) the element (element at a position (1, 4)) where the tilt angle Ta1 is registered, and zero is registered to elements where a tilt angle is not registered.

Note that although the tilt angle of an element with the registration of a tilt angle is copied to the two elements above and two elements below the element in this embodiment, it may be set so that the tilt angle of an element with the registration of a tilt angle will be copied to NN (NN is an integer equal to one or more) elements above the element and NN elements below the element. At this time, NN can be determined by using, as a reference, the size of the differential filter or the line pitch to be observed on the captured image.

Next, in step S307, the CPU 151 selects an unselected pixel among the pixels forming the captured image as the one selected pixel. The CPU 151 will then obtain an element value θ (a tilt angle or the value “0”) registered in the pixel position of the selected pixel on the above-described map. For example, if (2, 4) is the pixel position of the selected pixel, the CPU 151 will obtain the element value θ registered in the position (2, 4) on the map.

In step S308, the CPU 151 generates a rotation differential filter Srot by combining the Sobel filter Sv which has the differential direction in the v-axis direction and a Sobel filter Su which has the differential direction in the u-axis direction in accordance with the element value 8 obtained from the map in step S307. FIG. 4B shows an example of the arrangement of the Sobel filter Su. For example, the CPU 151 generates a rotation differential filter Srot(θ) by using the Sobel filter Sv, the Sobel filter Su, and the element value θ obtained from the map in step S307 to calculate

Srot(θ)=Sv×cos θ+Su×sin θ

The rotation differential filter is a differential filter that has a differential direction obtained by rotating the differential directions of the Sobel filter Sv and the Sobel filter Su by θ. FIG. 4C shows an example of the arrangement of the rotation differential filter Srot(θ).

In step S309, the CPU 151 applies the rotation differential filter Srot(θ) to the selected pixel. The application of the rotation differential filter Srot(θ) to the selected pixel is performed as follows by

grot(u,v)=Σₙ₌₋₁¹Σₘ₌₋₁¹f(u+m,v+n)Srot(m,n,θ)(u,v)) (2)

where f(u, v) represents a pixel value at the position (u, v) of the selected pixel in the captured image f. When (0, 0) is the center position of the differential filter obtained by combining the Sobel filters Sv and Su in accordance with an element value θ(u, v) corresponding to the position (u, v) of the selected pixel, Srot(m, n, θ(u, v)) represents an element value of a relative position (m, n) from the center position. In addition, grot(u, v) is a pixel value (luminance value) at the pixel position (u, v) in a differential image grot of the captured image f, and the pixel value is a pixel value obtained by applying the rotation differential filter Srot to the selected pixel of the captured image f.

In step S310, the CPU 151 determines whether every pixel of the captured image has been selected as a selected pixel. As a result of this determination, if every pixel in the captured image has been selected, the process advances to step S311, and if a pixel that has not been selected as a selected pixel remains in the captured image, the process returns to step S307. The differential image grot of the captured image f is completed by executing the processes of steps S307 to step S310 on every pixel in the captured image.

In step S311, for each vertical line (v-axis direction lines for each u coordinate point) of the differential image grot, the CPU 151 obtains, as a line coordinate point in the same manner as step S303, a coordinate point (peak position) where the differential value changes from positive to negative in the luminance distribution the vertical line.

In step S312, the CPU 151 performs the same process as that in step S304 described above on each line coordinate point obtained in step S311. That is, the CPU 151 will perform line labeling on the line coordinate points obtained in step S311, and each line coordinate point forming a line whose length is equal to or more than a predetermined value among the lines formed by the line coordinate points that have been assigned the same label will be set as the second line coordinate point.

FIG. 5C shows the second line coordinate points obtained by executing the processing in accordance with the flowchart of FIG. 3 in a case in which a captured image as shown in FIG. 2C is obtained in step S301. It is obvious that the detection accuracy has improved from the line coordinate points (FIG. 5B) obtained from the processes performed up to step S304. Since using the rotation differential filter Srot(θ) in this manner will allow a differential image corresponding to the line tilt angle to be obtained even when the line tilt angle changes for each location in in the image, line detection accuracy can be performed with high accuracy.

After the processing in accordance with the flowchart of FIG. 3 has been completed, the CPU 151 can use each line formed by the second line coordinate points assigned with the same label for the three-dimensional shape measurement of the object 5 to perform the three-dimensional shape measurement of the object 5 with higher accuracy. Note that the three-dimensional shape measurement result of the object 5 can be used for various kinds of uses.

<Modification 1>

Although the search direction of line coordinate points in step S311 can be rotated in accordance with the tilt angle in the same manner as the differential direction, since the dot induced noise of the differential response is reduced by rotating the differential direction, the detection accuracy is improved without changing the u-axis direction.

<Modification 2>

Although a rotation differential filter is obtained for each pixel in the first embodiment, a rotation differential filter may be obtained for each group by dividing the tilt angles obtained for pixels in a unit of a group of close tilt angles (a group of tilt angles in which the difference between the tilt angles is equal to or less than a predetermined value). In this case, a rotation differential filter corresponding to a group is obtained by using a representative tilt angle (an average value or a representative value of the tilt angles included in the group) of the tilt angles included in the group as the above-described element value θ. The rotation differential filter for each group is generated before the start of step S307. When a tilt angle corresponding to the selected pixel is specified, the rotation differential filter corresponding to the group to which the tilt angle belongs is applied to the selected pixel.

In addition, for example, a rotation differential filter is obtained for each predetermined tilt angle range in advance, and when a tilt angle corresponding to a selected pixel is specified, a rotation differential filter corresponding to the tilt range (the predetermined tilt angle range) including the tilt angle can be applied to the selected pixel. The predetermined tilt angle range may be obtained by dividing 360° into a plurality of ranges, for example, 0° to 9°, 10° to 19°, . . . , and 340° to 359°, and setting each divided range as the predetermined tilt angle range. Alternatively, a range in which the maximum value and the minimum value of a tilt angle obtained for each pixel may be set as the upper limit and the lower limit, respectively, and each range obtained by equally dividing this range into a plurality of ranges may be set as the predetermined tilt angle range. The rotation differential filter corresponding to a predetermined tilt angle range of interest can be obtained by using the representative tilt angle of the predetermined tilt angle range of interest (the median value of the predetermined tilt angle range of interest) as the element value θ. The rotation differential filter for each predetermined tilt angle range is generated before the start of step S307.

In this manner, the unit to be used to obtain the rotation differential filter is not limited to a specific unit. Also, instead of the tilt angle, it is possible to employ any kind of information as long as it is information representing the tilt of the line of the first line coordinate point such as information corresponding to the above-described cos θ and sin θ or the like.

<Modification 3>

Although the image capturing unit 3 and the projector 1 are arranged as separate devices in the first embodiment, the function of the image capturing unit 3 and the function of the projector 1 can be integrated into a single device.

### Second Embodiment

Differences from the first embodiment will be described hereinafter. Assume that parts not particularly mentioned below are the same as those in the first embodiment. In this embodiment, a differential image is generated by combining, in accordance with the line tilt for each pixel, two differential images whose differential directions are perpendicular to each other, and line detection is performed from the generated differential image. As a result, it becomes possible to obtain a result equal to the line detection accuracy improvement effect of the first embodiment.

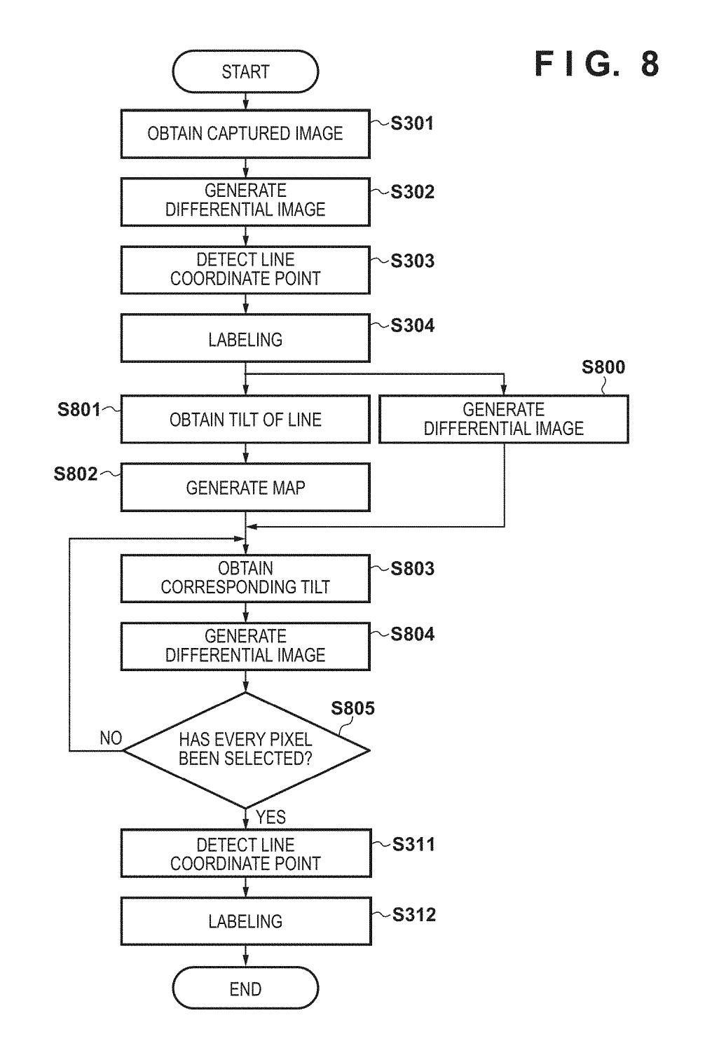

Processing performed by an arithmetic processing unit 4 to detect each line in a captured image obtained by an image capturing unit 3 will be described with reference to the flowchart of the processing shown in FIG. 8. In FIG. 8, the same reference numerals denote the same processing steps as those shown in FIG. 3, and a description thereof will be omitted.

In step S800, a CPU 151 generates a differential image gu by applying a Sobel filter Su which has a differential direction in a u-axis direction on each pixel of a captured image f loaded into a RAM 152 in step S301. The application of the Sobel filter Su on each pixel of the captured image f is performed by performing a convolution operation of the captured image f and a Sobel filter Sv by

gu(u,v)=Σₙ₌₋₁¹Σₘ₌₋₁¹f(u+m,v+n)Su(m,n) (3)

where Su(m,n) represents an element value at a relative position (m, n) with respect to the center position of the Sobel filter Su when the center position is set to (0, 0). In addition, gu (u, v) represents a pixel value (luminance value) at a pixel position (u, v) in the differential image gu. Note that the generation processing of the differential image gu need only be performed before the start of step S805 and is not limited to the processing order shown in FIG. 8. Since the process of step S800 is performed in parallel with the processes of steps S801 and S802 in FIG. 8, this parallel operation can contribute to reducing the computation time.

In step S801, the CPU 151 obtains, for each set of the first line coordinate points that have been assigned the same label (that is, the set of first lines forming the same line), a line tilt β of each first line coordinate point included in the set. For example, assume that v(n) is the v-coordinate value of a first line coordinate point P(n) whose u-coordinate value is n (n is an integer) in the first line coordinate point included in the set of interest. This this case, the line tilt 13 of the first line coordinate point P(n) can be obtained by calculating β=(v(n−1)−v(n+1))/2. Note that the line tilt β of a first line coordinate point (=umin) with the smallest u-coordinate value in the set of interest can employ the same angle as the line tilt β of a first line coordinate point P(umin+1). In addition, the line tilt β of a first line coordinate point (umax) with the largest u-coordinate value in the set of interest can employ the same angle as the line tilt β of a first line coordinate point P(umax−1). In this manner, the tilt is obtained for every first line coordinate point in step S801.

The process of step S802 differs from that of step S306 in only the point that the CPU 151 will use “the line tilt corresponding to each pixel of the captured image” instead of “the tilt angle corresponding to each pixel in the captured image” in the map generation processing performed in step S306 described above.

In step S803, the CPU 151 selects an unselected pixel among the pixels forming the captured image. The CPU 151 then obtains an element value (a tilt or the value “0”) registered in the pixel position of the selected pixel in the map generated in step S802.

In step S804, the CPU 151 obtains a pixel value corresponding to the selected pixel in a differential image grot obtained by combining a differential image gv generated in step S302 and the differential image gu generated in step S800 in accordance with the element value obtained in step S803. More specifically, the CPU 151 can calculate the pixel value corresponding to the selected pixel in the differential image grot by

grot(u,v)=gv(u,v)+gu(u,v)tan θ(u,v) (4)

where tan θ(u, v) corresponds to the element value registered in the position (u, v) in the map generated in step S802. That is, in this embodiment, since calculation using trigonometric functions will not be performed in the process until the differential image grot is generated, a line detection result equal to that of the first embodiment can be obtained at a lower computational cost than in the first embodiment where the differential image grot is generated by using trigonometric functions.

This point will be described with more specific detail. The differential image grot obtained by combining the differential image gv and the differential image gu by using the map generated in the first embodiment can be calculated by

grot(u,v)=gv(u,v)cos θ(u,v)+gu(u,v)sin θ(u,v) (5)

The differential image grot which is generated in accordance with equation (5) will be a differential image equal to the differential image grot generated in the first embodiment. Still, the map generated in the first embodiment is required to calculate equation (5), and thus an operation using the trigonometric functions as described above is required. However, since the right-hand side of equation (5) can be modified into the right-hand side of equation (4), the operation of equation (5) can be replaced by the operation of equation (4) which does not require the operation of the trigonometric functions. Thus, the differential image grot which is equal to that of the first embodiment can be obtained by the operation of equation (4) without using trigonometric functions. Note that in this embodiment, an operation needs to be performed by adding only the differential image gu to the first embodiment, and the overall computation amount is reduced compared to the first embodiment.

In step S805, the CPU 151 determines whether every pixel of the captured image has been selected as a selected pixel. As a result of this determination, if every pixel in the captured image has been selected, the process advances to step S311, and if a pixel that has not been selected as a selected pixel remains in the captured image, the process returns to step S803. The differential image grot of the captured image is completed by executing the processes of steps S803 and S804 for every pixel in the captured image. The subsequent processes to be performed are the same as those of the first embodiment.

### Third Embodiment

In the first and second embodiments, processing according to the flowchart of FIG. 3 and processing according to the flowchart of FIG. 8 are performed regardless of the direction of lines in the captured image. However, as described above, since it is possible to favorably detect a line from a differential image obtained by performing differentiation in the v-axis direction when each line is almost parallel with the u-axis direction, the processes of step S305 and subsequent steps and the processes of step S800 (S801) and subsequent steps may be omitted. Thus, for example, if the lines in the captured image are almost parallel to the u-axis direction, as shown in FIG. 2B, when the user confirms the lines in the captured image, the user can use an operation unit 154 to instruct the execution of the processes (first processing) of steps S301 to S304. On the other hand, assume that the lines in the captured image are tilted with respect to the u-axis direction, as shown in FIG. 2C, as a result of user confirmation of the lines in the captured image. In this case, the user can use the operation unit 154 to instruct the execution of the first processing and the processes of step S305 and subsequent steps or the processes (second processing) of step S800 (S801) and subsequent steps. A CPU 151 will execute the first processing or the first processing and the second processing in accordance with the execution instruction from the operation unit 154. Note that the method of determining whether the lines in the captured image are almost parallel to or tilted with respect to the u-axis direction is not limited to visual confirmation by the user. A determination can be made by executing image processing by using an arithmetic processing unit 4.

In addition, it may be arranged so that the first processing will be executed by a device other than the arithmetic processing unit 4, and in such a case, the arithmetic processing unit 4 will obtain the result of the first processing executed by the other device.

Note that some or all of the above-described embodiments and modifications may be combined appropriately. In addition, some or all of the above-described embodiments and modifications may be selectively used.

### Fourth Embodiment

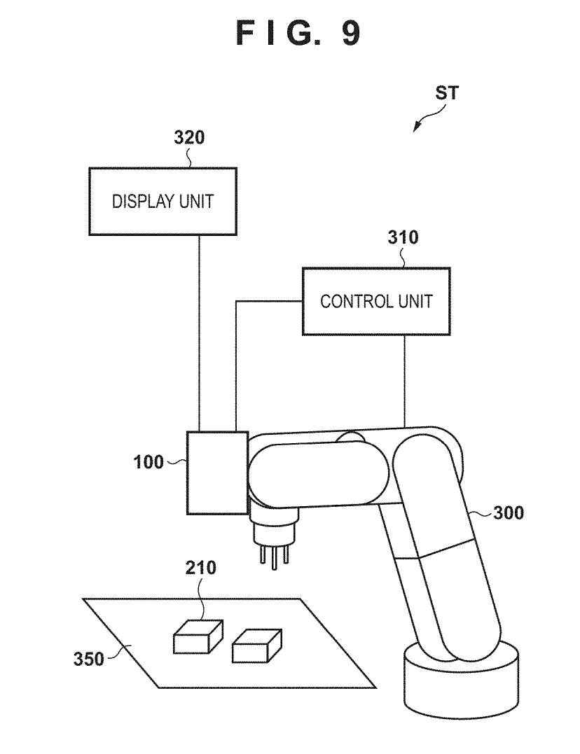

A three-dimensional coordinate measurement apparatus 100 as described above can be used in a state supported by a given support member. This embodiment will describe, as an example, a control system to be included and used in a robot arm (holding apparatus) 300 as shown in FIG. 9. The three-dimensional coordinate measurement apparatus 100 obtains an image by projecting pattern light to an object 210 to be inspected placed on a support base 350 and capturing an image of the object. Subsequently, the position and the posture of the object 210 is obtained by a control unit of the three-dimensional coordinate measurement apparatus 100 or a control unit 310 which obtains image data from the control unit of the three-dimensional coordinate measurement apparatus 100, and the control unit 310 obtains the information of the obtained position and posture. The control unit 310 controls the robot arm 300 by transmitting a driving instruction to the robot arm 300 based on the information of the position and the posture. The robot arm 300 holds the object 210 by a robot hand (a holding unit) or the like arranged at its tip and moves the object by, for example, translating or rotating it. Furthermore, the robot arm 300 can manufacture an article formed by a plurality of parts such as an electronic circuit board or a machine by attaching the object 210 to another part to assemble the article. It is also possible to manufacture an article by processing the moved object 210. The control unit 310 includes an arithmetic device such as a CPU and a storage device such as a memory. Note that a control unit for controlling the robot may also be provided outside the control unit 310. Note also that measurement data and images obtained by the three-dimensional coordinate measurement apparatus 100 can be displayed on a display unit 320 such as a display.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-083368, filed Apr. 24, 2018, which is hereby incorporated by reference herein in its entirety.

What is claimed is:

1. An image processing apparatus comprising:
an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel; and
a detection unit configured to detect the line in the image based on the tilt obtained by the obtainment unit for each pixel.

2. The apparatus according to claim 1, wherein the obtainment unit obtains the tilt of each of a plurality of coordinate points based on the plurality of coordinate points where the luminance is at a peak in a differential image of the image, and sets the tilt obtained for the coordinate point to be the tilt of the line corresponding to a pixel in the image corresponding to the coordinate point.

3. The apparatus according to claim 1, wherein the obtainment unit generates a map for registering the tilt of the line obtained for a coordinate point where the luminance is at a peak in a differential image of the image as the tilt of the line corresponding to the pixel in the image corresponding to the coordinate point.

4. The apparatus according to claim 1, wherein the detection unit generates a rotation differential filter by combining a differential filter which has a differential direction in a horizontal direction and a differential filter which has a differential direction in a vertical direction based on the tilt obtained by the obtainment unit for the pixel, generates a differential image of the image by applying the rotation differential filter to the pixel, and detects the line from the differential image.

5. The apparatus according to claim 1, wherein the detection unit generates a rotation differential filter by combining a differential filter which has a differential direction in a horizontal direction and a differential filter which has a differential direction in a vertical direction based on a representative tilt of a tilt range including the tilt obtained by the obtainment unit for the pixel, generates a differential image of the image by applying the rotation differential filter to the pixel, and detects the line from the differential image.

6. The apparatus according to claim 1, wherein the detection unit detects the line from a differential image obtained by combining, based on the tilt obtained by the obtainment unit for the pixel, a differential image obtained by performing differentiation on the image in a horizontal direction and a differential image obtained by performing differentiation on the image in a vertical direction.

7. The apparatus according to claim 1, further comprising a unit configured to measure a three-dimensional shape of the object based on the line detected by the detection unit.

8. A system comprising:
an image processing apparatus that includes
an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel, and
a detection unit configured to detect the line in the image based on the tilt obtained by the obtainment unit for each pixel; and
a robot configured to hold and move the object based on a measurement result obtained by the image processing apparatus.

9. A method of manufacturing an article, the method comprising:
measuring an object by using an image processing apparatus that includes
an obtainment unit configured to obtain, for each pixel corresponding to a line detected from an image of the object that has been obtained by an image obtainment unit configured to obtain the image of the object on which a pattern including the line has been projected, a tilt of the line corresponding to the pixel, and
a detection unit configured to detect the line in the image based on the tilt obtained by the obtainment unit for each pixel; and
manufacturing the article by processing the object based on the measurement result.

10. An image processing method performed by an image processing apparatus, the method comprising:
obtaining, for each pixel corresponding to a line detected from an image of an object that has been obtained by an image obtainment unit configured to obtain the image of the object on which a pattern including the line has been projected, a tilt of the line corresponding to the pixel; and
detecting the line in the image based on the tilt obtained for each pixel.

11. A non-transitory computer-readable storage medium storing a computer program for causing a computer to function as:
an obtainment unit configured to obtain, for each pixel corresponding to a line detected from an image of an object that has been obtained by an image obtainment unit configured to obtain the image of the object on which a pattern including the line has been projected, a tilt of the line corresponding to the pixel; and
a detection unit configured to detect the line in the image based on the tilt obtained by the obtainment unit for each pixel.
